(19) United States
(12) Patent Application Publication
(10) Pub. No.: US 2004/0024707 A1
(43) Pub. Date: Feb. 5, 2004

(54) Dynamic merchant pricing model

(76) Inventors: Anthony R. Perre, Higley, AZ (US); Stuart Rosenbaum, Sunnyvale, CA (US)

Correspondence Address: GLENN PATENT GROUP, 3475 EDISON WAY, SUITE L, MENLO PARK, CA, 94025, US

(21) Appl. No.: 10/393,206

(22) Filed: Mar. 18, 2003

Related U.S. Application Data
(60) Provisional application No. 60/365,450, filed on Mar. 18, 2002.

(51) Int. Cl. G06F 17/60

(52) U.S. Cl. 705/42; 705/39

(57) ABSTRACT

The presently preferred embodiment of the invention comprises a dynamic merchant pricing model that provides any of the following for new and existing merchants: A new or existing merchant is provided with a number of bankcard processing options from which to choose that best suits the needs of the merchant's company, and not what best suits the financial gains of the bank or ISO. Merchants are provided with an option to choose a bankcard processing program that does not penalize their business, based on the facts that they either have little or light processing volumes within the first calendar year, e.g. <$1,000 per month, or processing volumes below the financial break even levels of a traditional bankcard processing program, e.g. <$1,000 per month. Merchants are provided with an on-line merchant statement at the end of each month. Within the month end statement, various other bankcard processing pricing programs are offered as an alternative choice to the merchant's existing processing program. The merchant is also able to view what they would have paid had they chosen one of the other processing programs based on the month-end bankcard processing volume their business completed the prior month, as that volume is reflected on the merchant's month end statement. Merchants are provided with an option to switch bankcard processing programs automatically at the end of each month to a program that best suits the needs of their company.

### CROSS-REFERENCE TO RELATED APPLICATIONS

This application claims priority to U.S. patent application Ser. No. 60/365,450, filed Mar. 18, 2002.

### BACKGROUND OF THE INVENTION

### TECHNICAL FIELD

The invention relates to merchant credit card processing. More particularly, the invention relates to a dynamic merchant pricing model.

### DESCRIPTION OF THE PRIOR ART

Banks and Independent Sales Organizations (ISO) provide a bankcard payment acceptance service for merchants in the physical and virtual, i.e. e-commerce, world. These organizations typically charge “one size fits all” traditional processing fees including, but not limited to, a set-up fee, a discount rate, a transaction fee, a monthly minimum fee, a customer service fee, a statement fee, a credit-card equipment fee, and a secure payment gateway fee.

To date, the aforementioned organizations usually dictate to prospective merchants the bankcard processing fees that the merchants are to be charged. The merchants do not have a viable option in connection with such fees other than to shop around for a more attractive “one size fits all” traditional processing program, as described above. Once a merchant signs-up with a bank or ISO, the merchant is usually locked into a contract whereby they pay one type of traditional bankcard processing fee and have no opportunity to switch to a more financially beneficial individual merchant account payment processing program unless they cancel their current account, pay a cancellation fee, and re-apply with another merchant account provider.

It would be desirable for merchants to have the ability to accept all card types at the physical/virtual point of sale. Unfortunately, regardless of whether the merchant is large or small, new or existing, very little processing volume, low/medium or large processing volume, the banks and ISOs charge the same “one size fits all” traditional fees. There are a significant number of merchants in both the physical and virtual worlds that never or rarely ever transact enough bankcard payments to justify or break even with the investment they have to make, e.g. up-front and ongoing monthly fees per their contract with bank/ISO, when they contract for such service.

The traditional bankcard processing fees paid by all merchants generate a significant amount of revenue for the banks and ISOs. The merchants have no choice other than to accept the terms and traditional bankcard processing fee structures offered to them by their bank or ISO. Banks and ISOs to date have failed to solve the aforementioned problems facing new and existing merchants because they have been unwilling to jeopardize their traditional healthy sources of revenues, e.g. up-front and ongoing monthly fees.

It would be advantageous to provide a more flexible, merchant controlled pricing model for such bankcard services.

### SUMMARY OF THE INVENTION

The presently preferred embodiment of the invention comprises a dynamic merchant pricing model that provides any of the following for new and existing merchants:

A new or existing merchant is provided with a number of bankcard processing options from which to choose that best suits the needs of the merchant's company, and not what best suits the financial gains of the bank or ISO.

Merchants are provided with an option up-front as well as each and every month, to choose from a suite of individual merchant account payment processing options that, from a financial standpoint best fits the business requirements of the said merchant; and does not penalize their business in the form of paying required up-front and monthly fees, based on the facts that they either have little or light processing volumes within the first calendar year, e.g. <$1,000 per month, or processing volumes below the financial break even levels of a traditional bankcard processing program, e.g. <$1,000 per month.

Merchants are provided with an on-line merchant statement at the end of each month. Within the month end statement, various other internal individual merchant account bankcard processing pricing programs are offered as an alternative choice to the merchant's existing processing program. The merchant is able to view what they currently are being charged with their existing chosen merchant account plan, as well as what they would have paid and saved had they chosen one of the other internal individual merchant account processing programs. The above-mentioned scenario is based on the month-end bankcard processing volume their business completed the prior month, as that volume is reflected on the merchant's month end statement.

If the merchant feels that based on the realized cost savings of another internal individual merchant account option that was presented to them via their month end statement, that they would like to switch to the most financially beneficial payment processing plan, the merchant has the ability to dynamically switch to the said plan automatically for the next payment processing month. The merchant indicates their desire to switch plans by filling out the appropriate information supplied by company. To switch from one program to another, the merchant simply selects the desired option by clicking through on-line. The above-mentioned scenario repeats itself each and every month.

### BRIEF DESCRIPTION OF THE DRAWINGS

FIG. 1 is an illustration of a merchant statement according to the invention; and

FIG. 2 is a block schematic diagram showing the constituent elements and operation of a dynamic pricing model according to the invention.

### DETAILED DESCRIPTION OF THE INVENTION

The presently preferred embodiment of the invention comprises a dynamic merchant pricing model that provides any of the following for new and existing merchants:

A new or existing merchant is provided with a number of individual merchant account bankcard processing options from which to choose that best suits the needs of the merchant's company, and not what best suits the financial gains of the bank or ISO;

Merchants are provided with an option up-front as well as each and every month, to choose from a suite of individual merchant account payment processing options that, from a financial standpoint best fits the business requirements of the said merchant; and does not penalize their business in the form of paying required up-front and monthly fees, based on the facts that they either have little or light processing volumes within the first calendar year, e.g. <$1,000 per month, or processing volumes below the financial break even levels of a traditional bankcard processing program, e.g. <$1,000 per month.

Merchants are provided with an on-line merchant statement at the end of each month. Within the month end statement, various other internal individual merchant account bankcard processing pricing programs are offered as an alternative choice to the merchant's existing processing program. The merchant is able to view what they currently are being charged with their existing chosen merchant account plan, as well as what they would have paid and saved had they chosen one of the other internal individual merchant account processing programs.

The above-mentioned scenario is based on the month-end bankcard processing volume their business completed the prior month, as that volume is reflected on the merchant's month end statement.

Merchants are provided with an option to switch bankcard processing programs automatically at the end of each month to another internal individual merchant account payment processing program that best suits the needs of their company.

### Dynamic Merchant Pricing

Dynamic merchant pricing, as used herein, refers to the process of providing merchants with the ability to choose from a spectrum of merchant controlled payment processing solutions one or more of these solutions that is best suited for the merchant's business. After a payment processing solution is chosen, the merchant has the ability up-front as well as at the end of each month to switch dynamically to an alternative merchant pricing option for the next proceeding month. Based on switching to the new payment pricing option, the merchant's statement also provides the merchant with the total amount of savings realized for that month.

The invention provides a solution to the merchant's perceived barrier to entry to using payment processing solutions, and provides alternative payment methods that many on-line and physical world businesses currently seek, i.e. it is a dynamic merchant pricing model. With dynamic merchant pricing, the owner of a small business can choose which category of pricing best suits his needs. Once chosen, the merchant is not locked in to a particular merchant account payment processing pricing model, but can select other merchant account pricing models according to which is most beneficial to their business.

These categories may include, but are not limited to, for example:

Pay4Play

In this embodiment of the invention, the merchant incurs no set up fees, is not required to purchase any equipment because processing is done by telephone or via the Internet, and incurs no monthly fees. Merchants in this category pay higher discount rates and transaction fees than a traditional merchant account offers.

Typical Pricing:

No set-up or ongoing monthly fees

Discount rate—3.75%

Transaction fee—$0.50 cents per transaction

A merchant would choose this option based on the fact that there are no set-up or monthly recurring fees. The discount rate and transaction fees are typically higher than a traditional merchant pricing program; but the merchant is not charged any monthly minimum fees if there is little or in some cases zero monthly bankcard volume activity.

Advantages:

This option is designed specifically for the new merchant who is concerned about the financial barrier to entry that exists when signing up with a traditional fixed pricing payment processing option. A traditional fixed pricing option typically includes a set-up fee, e.g. $299.00-$799.00, and an ongoing monthly fee, e.g. $15.00-$100.00. Typically, a merchant who processes less than $1,000 per month would use a Pay4Play payment option.

A merchant would also choose this option, as opposed to typical non-traditional payment processing options, such as PayPal or BillPoint. PayPal or BillPoint provide an email- based person-to-person payment system that typically does not meet the needs of merchants who transact business in the business-to-consumer sector.

The Pay4Play option offers the best features of the non-traditional email based peer-to-peer “P2P” solution, e.g. there are no set-up or monthly recurring fees, while also providing the merchant with the advantage of receiving the in-depth reporting, customer service, and settlement tools that a merchant needs to run their business properly.

Select

In this category, the merchant pays a small set up fee and has access to more services. The discount rates and transactions fees are lower than Pay4Play, but are still higher than a traditional merchant account.

Typical Pricing:

Sign-up fee—$99.00 per year

No ongoing monthly minimum or gateway fees

Discount rate—2.75%

Transaction fee—0.40 cents per transaction

A merchant would typically select this option because of the modest set-up fee and because there are not any ongoing monthly fees. The discount rate and transaction fees are lower than the Pay4Play option, but higher than the traditional merchant account payment processing option. The traditional option, discussed below, includes a higher set-up and recurring monthly fees.

Advantages:

This option is designed specifically for the merchant who is processing up to, for example, $3,000 per month in bankcard volume. The modest set-up fee, e.g. $99.00, and the fact that there are no recurring monthly fees are much more palatable than the aforementioned typical traditional set-up and ongoing monthly fees.

Once a merchant starts processing more than $3,000 per month, the lower price points, i.e. discount rate and transaction fee, of the traditional pricing model provide a more financially beneficial pricing option.

Traditional

In this category, the merchant pays a greater set up fee than in the Select category, is provided the lowest offered rates and transaction fees, and generally purchases or leases equipment or software. The merchant also pays a monthly fee and has the option of receiving hardcopy monthly statements.

Typical Pricing:

Set-up fee—$199.00

Discount rate—2.35%

Transaction fee—0.30 cents per transaction

Monthly service fee—$20.00(includes customer service and statement fee)

Equipment fee—$399.00 purchase or $19.95 per month for 24-36 months

If virtual world- Gateway set-up fee—$99.00

If virtual world- Monthly Gateway fee—$15-20.00 per month

A merchant would typically select this option because they are processing more than, for example, $2,000 per month in bankcard processing volume.

Advantages:

A merchant can justify the higher set-up and monthly fees based on the fact that the monthly bankcard processing volumes are calculated against the lowest discount rate and transaction fee offered amongst the new suite of payment processing options.

The major benefit of using the new suite of payment processing options is that, when used in concert with one another, the merchant has the flexibility to change options dynamically and at their discretion.

### Merchant Rewards

Various rewards may be provided to merchants based upon any of various factors. For example, for merchants in the Traditional category that process above a certain amount, e.g. $10,000 per month for a minimum of six months, are in low risk categories, have charge backs below, for example 0.25%, and pay their monthly bills on time, the merchant receives additional rewards, such as lower surcharges on non-qualified transactions, lower discount rates, and lower transaction fees.

### Operation of a Preferred Embodiment

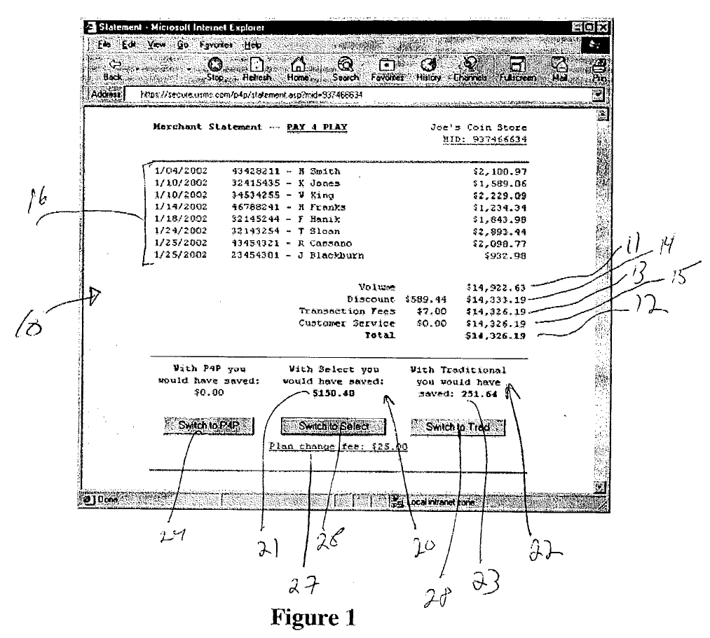

FIG. 1 is an illustration of a merchant statement according to the invention. At the end of each month, the merchant is provided with a statement 10 that itemizes the merchant's transactions 16, and that re-caps the merchant's total amount of bankcard processing volume 11, along with the fees charged for the particular payment processing option currently selected by the merchant 13. The merchant is also provided with totals for discounts (if applicable) 14, customer service fees (if applicable) 15, and a grand total 12.

In addition to the chosen payment processing option, one or more alternative options 20, 22 are provided for the merchant to view. The alternative options also include a calculation 21, 23 to reflect what the merchant would have paid in fees if the merchant had chosen one of the alternative payment pricing options.

After carefully reviewing the bottom-line cost of each of the payment processing options, the merchant has a choice either to continue with the existing payment option, or to switch to one of the other additional payment processing options for the next proceeding month. In the presently preferred embodiment of the invention, a merchant switches options by clicking on the appropriate payment pricing option, e.g. via the “Switch to Select” button 24, 26, 28 associated with the desired payment pricing option, and then clicking “yes” to re-verify that they are sure that they want to switch to the newly chosen payment processing option.

In the example shown on FIG. 1, the merchant is currently in the Pay4Play payment pricing option. While a “Switch to Select” button 24 is shown for this option, selecting this button it does not affect the merchant's current status. Thus, in some embodiments of the invention, this button may be grayed out or may not be displayed. Additionally, a change in the payment pricing option may engender additional costs, as well as savings. Thus, a “Plan Change fee” 27 is shown on FIG. 1 in connection with the Select option.

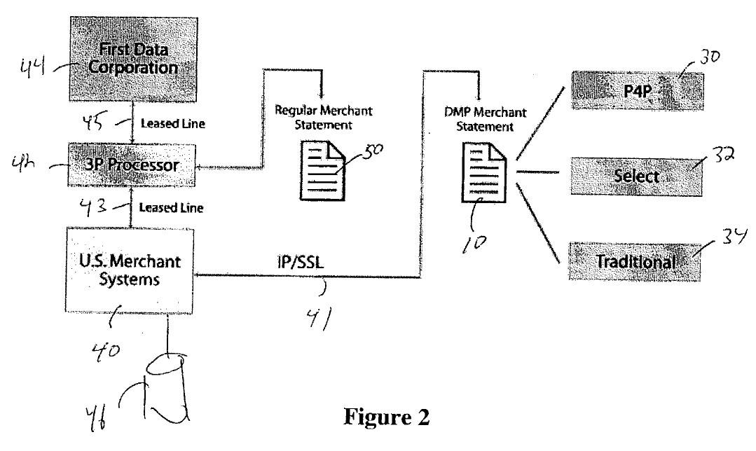

FIG. 2 is a block schematic diagram showing the constituent elements and operation of a dynamic pricing model according to the invention. In FIG. 2, a three party processor 42 is shown which processes transactions in a manner well known in the art. Credit information is provided to such processor via a leased line 45 from a credit agency 44, e.g. First Data Corporation. In such setting, a merchant may receive a statement 50 in a manner that is well known in the art. The foregoing describes a typical merchant transaction processing system. Those skilled in the art will appreciate that other such systems can be used in connection with the invention herein disclosed without departing from the scope and spirit of the invention.

The invention comprises a further service, which in this embodiment is a server 40, e.g. Dynamic Merchant Services and or U.S. Merchant Systems, that receives transaction information via a leased line 43 from a typical transaction processing system, such as the described above. A merchant who is signed up with the inventive service accesses the server via the Internet with a browser, such as Netscape Navigator, using the well known Internet protocol and secure socket layer technology. The merchant receives a statement 10 in this manner on a periodic basis, which in this embodiment of the invention is a monthly basis. The statement provides the merchant with information concerning various payment processing options 30, 32, 34 as discussed above. The merchant can then switch options on a regular basis, as is appropriate for their current level of business activity. The server includes a program that calculates the costs of each plan, based upon the merchant's current data, and that prepares a Web page which presents this information to the merchant. The software also detects when a merchant makes a selection of a different plan, and proceeds to process the merchant's future transactions in accordance with the selected plan. Information used by the software to determine the cost for the plan, both merchant data and plan data, can be obtained by the server 40 from various locations, such as a local database 46, or from various sources of information that are available through a payment processing system 42, 44.

The server is operated by a service that has entered into relationships with various processing service vendors. Merchant options are provided in accordance with preexisting and/or negotiated rates, based upon volumes of service, and based upon the likely volume of business generated by the service, which presents a volume opportunity to the processing service vendors. Thus, the invention also provides a mechanism for aggregating merchant demand for processing services. The service itself derives revenue from merchant subscription fees, processing service vendor referral fees, advertising, merchandising, or any combination of the above.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for dynamic merchant pricing, comprising:
means for providing a merchant with a number of bankcard processing options from which to choose; and
means for providing said merchant with a periodic on-line merchant statement, wherein said statement comprises at least one other bankcard processing pricing program that is offered to said merchant as an alternative choice to said merchant's existing processing program.

2. The apparatus of claim 1, further comprising:
means for allowing said merchant to view what they would have paid had they chosen one of the other processing programs based on said merchant's bankcard processing volume completed during a prior period, as that volume is reflected on said merchant's statement.

3. The apparatus of claim 1, further comprising:
means for providing said merchant with an option to switch bankcard processing programs automatically at the end of each period to a program that best suits said merchant's needs.

4. The apparatus of claim 3, wherein to switch from one program to another, said merchant selects a desired option by clicking through on-line.

5. The apparatus of claim 1, said options comprising at least any of a bankcard processing program suited for light processing volumes within an initial period of time; and for processing volumes below financial break even levels of a traditional bankcard processing program.

6. A dynamic merchant pricing method, comprising the steps of:
providing a merchant with a choice of one payment processing option from a plurality of payment processing solutions; and
after a payment processing option is chosen, providing said merchant with the ability at the end of a period to switch dynamically to an alternative merchant pricing option for a next proceeding period.

7. The method of claim 6, further comprising the step of:
providing said merchant with a total amount of savings realized for period, based upon said merchant switching to a new payment pricing option.

8. The method of claim 6, wherein one of said plurality of payment processing options comprises, inter alia, a payment processing option in which said merchant incurs no set up fees, is not required to purchase any equipment because processing is done by telephone or via the Internet, and incurs no monthly fees; and wherein with this option said merchant pays higher discount rates and transaction fees than with a traditional merchant account.

9. The method of claim 6, wherein one of said plurality of payment processing options comprises, inter alia, a payment processing option in which said merchant incurs a small set up fee and has access to more services; and wherein with this option said merchant pays discount rates and transaction fees that are higher than with a traditional merchant account.

10. The method of claim 6, wherein one of said plurality of payment processing options comprises, inter alia, a payment processing option in which said merchant incurs a greater set up fee, is provided the lowest offered rates and transaction fees, and purchases or leases equipment or software; and wherein with this option said merchant pays a monthly fee and has the option of receiving hardcopy monthly statements.

11. The method of claim 6, wherein any of various rewards may be provided to said merchant based upon any of various factors.

12. The method of claim 11, wherein for a merchant who processes above a certain amount per period for a minimum number of periods, is in low risk categories, has charge backs below a predetermined level, and pays his monthly bills on time, said merchant receives additional rewards, which may comprise any of lower surcharges on non-qualified transactions, lower discount rates, and lower transaction fees.

13. A dynamic merchant pricing method, comprising the steps of:
providing a merchant with a statement at the end of each month, that itemizes said merchant's transactions, and that re-caps said merchant's total amount of bankcard processing volume, along with fees charged for a particular payment processing option currently selected by said merchant;
providing said merchant with totals for discounts (if applicable), customer service fees (if applicable), and a grand total; and
providing said merchant with one or more alternative payment processing options, wherein said one or more alternative payment processing options comprise a calculation to reflect what said merchant would have paid in fees if said merchant had chosen one of the alternative payment pricing options.

14. The method of claim 13, further comprising the step of: providing said merchant with a choice either to continue with an existing payment option, or to switch to one of said other additional payment processing options for the next proceeding month.

15. An apparatus for providing dynamic merchant pricing, comprising:
a server that receives transaction information from a transaction processing system;
access means for allowing a merchant to access said server to receive a statement on a periodic basis;
said statement providing said merchant with information concerning various payment processing options; and
means for allowing said merchant to switch options on a regular basis, as is appropriate for said merchant's current level of business activity.

16. The apparatus of claim 15, said server further comprising:
a program that calculates costs to said merchant of each payment processing option, based upon said merchant's current data; and
means for presenting said costs to said merchant.

17. The apparatus of claim 16, said server further comprising:
means for detecting when a merchant makes a selection of a different payment processing option; and
means for processing said merchant's future transactions in accordance with said selected payment processing option.
